(19) United States
(12) Patent Application Publication
(10) Pub. No.: US 2026/0133615 A1
(43) Pub. Date: May 14, 2026

(54) SYSTEM FOR DYNAMIC POWER MANAGEMENT IN SIGNAL CONDUCTORS

(71) Applicant: MELLANOX TECHNOLOGIES, LTD., Yokneam (IL)

(72) Inventors: Michael WEINER, Nes Ziona (IL); Nir SUCHER, Ramat Hashofet (IL); Amit KAZIMIRSKY, Givat Shmuel (IL); Tal SERFATI, Kiryat Motzkin (IL); Tomer SHACHAR, Kiryat Tiv'on (IL); Eyal ZELER, Sunnyvale, CA (US)

(73) Assignee: MELLANOX TECHNOLOGIES, LTD., Yokneam (IL)

(21) Appl. No.: 18/943,347

(22) Filed: Nov. 11, 2024

(51) Int. Cl. G06F 1/3203; G06F 13/42

(52) U.S. Cl. CPC G06F 1/3203; G06F 13/4221; G06F 2213/0026

(57) ABSTRACT

Systems, computer program products, and methods are described for dynamic power management in signal conductors, such as PCIe links. An example system determines an imminent change in link usage based on a combination of the received historical and predicted link usage information. In response, the example system either triggers a transition from a current operational state to a subsequent operational state, or dynamically adjusts a time period associated with the transition of the signal conductor from a current operational state to a subsequent operational state. These operational states are defined within a predefined sequence of operational power states, ranging from low-power states to active states. The adjustment of the transition time period serves as a mechanism to accommodate variations in link usage patterns, ensuring that transitions between operational states are both timely and efficient, optimizing the link's operational efficiency and reducing potential delays in data processing.

### TECHNOLOGICAL FIELD

Example embodiments of the present disclosure relate to a system for dynamic power management in signal conductors.

### BACKGROUND

Conventional implementation of active state power management (ASPM) for power management in Peripheral Component Interconnect Express (PCIe) links may introduce several challenges that can affect PCIe connected device performance and energy efficiency.

Applicant has identified a number of deficiencies and problems associated with power management in signal conductors such as PCIe. Many of these identified problems have been solved by developing solutions that are included in embodiments of the present disclosure, many examples of which are described in detail herein.

### BRIEF SUMMARY

Systems, methods, and computer program products are therefore provided for dynamic power management in signal conductors.

In one aspect, a system for dynamic power management in signal conductors is presented. The system comprising: a signal conductor; a control unit operatively coupled to the signal conductor, wherein the control unit is configured to: receive historical link usage information and predicted future link usage information associated with the signal conductor; determine an imminent change in link usage based on the historical link usage information and the predicted future link usage information received; and trigger the signal conductor to transition from a current operational state to a subsequent operational state in response to determining the imminent change.

In some embodiments, the control unit is further configured to: dynamically adjust a time period associated with transitioning the signal conductor from the current operational state to the subsequent operational state based on the imminent change in link usage, wherein the current operational state and the subsequent operational state are defined in a sequence of operational power states; and trigger the signal conductor to transition from the current operational state to the subsequent operational state upon a lapse of the adjusted time period.

In some embodiments, the imminent change in link usage is a decreased link usage, wherein the control unit is configured to dynamically adjust the time period by reducing the time period, and wherein the subsequent operational state is a low-power state immediately succeeding the current operational state in the defined sequence of operational power states.

In some embodiments, the imminent change in link usage is an increased link usage, wherein the control unit is configured to dynamically adjust the time period by reducing the time period, and wherein the subsequent operational state is a high-power state immediately preceding the current operational state in the defined sequence of operational power states.

In some embodiments, in an instance in which the historical link usage information and the predicted link usage information provide conflicting indications regarding the imminent change in link usage, the control unit is configured to dynamically adjust the time period by increasing the time period.

In some embodiments, the control unit is configured to: reset the time period associated with transitioning the signal conductor from the current operational state the subsequent operational state to a default value.

In some embodiments, the control unit is configured to determine an imminent duration of inactivity in the signal conductor based on the historical link usage information and the predicted link usage information, wherein, in an instance in which the imminent duration of inactivity is determined, the control unit is configured to dynamically adjust the time period by reducing the time period, and wherein the subsequent operational state is a low-power operational state.

In some embodiments, the low-power operational state is a terminal state in the defined sequence of operational power states.

In some embodiments, the low-power operational state immediately succeeds the current operational state in the defined sequence of operational power states.

In some embodiments, the current operational state is a low-power operational state, the imminent change in link usage is an increased link usage, wherein the control unit is further configured to dynamically adjust the time period by reducing the time period, the subsequent operational state is an active power operational state in the defined sequence of operational power states; and the control unit is configured to trigger the signal conductor to transition from the current operational state to the subsequent operational state such that the signal conductor is in the subsequent operational state prior to the increased link usage.

In some embodiments, the active power operational state is an initial state in the defined sequence of operational power states.

In some embodiments, the signal conductor is a peripheral component interconnect express (PCIe) link, and wherein the defined sequence of operational power states comprises L0, L0p, L1, L2, and L3 power states.

In another aspect, a method for dynamic power management in signal conductors is presented. The method comprising: receiving historical link usage information and predicted future link usage information associated with a signal conductor; determining an imminent change in link usage based on the historical link usage information and the predicted future link usage information; and triggering the signal conductor to transition from a current operational state to a subsequent operational state in response to determining the imminent change.

In yet another aspect, a computer program product for dynamic power management in signal conductors is presented. The computer program product comprising a non-transitory computer-readable medium comprising code configured to cause an apparatus to: receive historical link usage information and predicted future link usage information associated with the signal conductor; determine an imminent change in link usage based on the historical link usage information and the predicted future link usage information received; and trigger the signal conductor to transition from a current operational state to a subsequent operational state in response to determining the imminent change.

In yet another aspect, a control unit is presented. The control unit comprising: a processor; a non-transitory storage device containing instructions that, when executed by the processor, cause the processor to: receive historical link usage information and predicted future link usage information associated with a signal conductor; determine an imminent change in link usage based on the historical link usage information and the predicted future link usage information received; and trigger the signal conductor to transition from a current operational state to a subsequent operational state in response to determining the imminent change.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates an example PCIe-based interconnect architecture for dynamic power management in signal conductors, in accordance with an embodiment of the present disclosure;

FIG. 2 illustrates example control unit circuitry for dynamic power management in signal conductors, in accordance with an embodiment of the present disclosure;

FIG. 3 is a block diagram that illustrates a computing system, such as a datacenter or a High-Performance Computing (HPC) cluster, in accordance with an embodiment described herein; and

FIG. 4 illustrates an example method for dynamic power management in signal conductors, in accordance with an embodiment of the present disclosure.

### DETAILED DESCRIPTION

### Overview

In Deep Learning (DL) systems, addressing the challenges of efficiently managing computational resources, especially Graphics Processing Units (GPUs), is important. These systems are designed to partition and distribute large workloads across multiple, distinct GPUs, to achieve scalable processing capabilities. During operation, the GPUs synchronize the data they process with that of their counterparts, resulting in a collective synchronization mechanism. This process ensures that every GPU completes the transmission and reception of all pertinent data before advancing to the subsequent processing task. This synchronization may result in a distinctive “wavelet-like” traffic pattern across the interconnect fabric (e.g., InfiniBand® communication network) that links the GPUs that is characterized by short duty cycles punctuated by relatively extended periods of inactivity. As part of the interconnect fabric, Network Interface Controllers (NICs) and GPU-Direct technologies may be employed to offload GPU synchronization tasks. These NICs interface with GPUs through connections such as PCI-Express (PCIe) connections, NVLINK®, GRS (Ground Reference Signaling), LPI (Low Power Interface) LLI (Low latency interface), and/or the like.

PCIe specification includes various low power standby states—L1, L2, and L3—that are designed to regulate power consumption in PCIe connected devices, including GPUs. These states represent a graduated scale of power-saving modes in contrast with the active state, L0—a higher power usage. The L1 state is a moderate power-saving mode where the PCIe connected device and the PCIe link significantly reduce their power consumption but can quickly resume full operation. As such, the L1 state is configured to offer a balance between reduced power consumption and minimal impact on wake-up latency. The L2 state is a deeper power-saving state as compared to the L1 state, involving more substantial power reduction for both the PCIe connected device and the PCIe link. As such, the L2 state presents a midpoint in this spectrum, offering more substantial power savings than the L1 state but with a correspondingly longer latency for entrance and exit. The L3 state represents the deepest level of power saving, where the device is essentially turned off, and the PCIe link is completely powered down. As such, the L3 state is used in conditions where no immediate use of the device is expected, and power conservation is prioritized over quick resumption of activity. Recovery from the L3 state requires the most time among the standby states, as it necessitates a complete reinitialization of the PCIe link and the PCIe connected device. As such, each of these standby states introduces a trade-off between power saving and operational responsiveness, with L1 prioritizing speed of wake-up, L3 prioritizing power conservation, and L2 balancing the two.

PCIe specification also includes an enhanced power saving mode, the L0p state, that operates within the active L0 state and is designed to reduce power consumption without significantly impacting the device's operational readiness or performance. Unlike the deeper sleep states (e.g., L1, L2, and L3), which offer greater power savings at the expense of higher latency when waking up, the L0p state allows for power reduction while maintaining at least one lane of the PCIe link in an active state, ensuring uninterrupted data transfer. The design of the L0p state enables PCIe connected devices to reduce their power draw significantly while in a near-idle condition, without fully entering a sleep state. The transition into and out of L0p is rapid, ensuring that the device can quickly resume full data transmission with minimal delay.

PCIe configurations can vary in the number of lanes—fundamental channels through which data is transmitted and received between devices. PCIe configurations may be commonly referred to as ×1, ×4, ×8, ×16, etc., indicating the number of lanes and, consequently, the bandwidth capacity of the connection. The more lanes a particular signal conductor has, the higher the data transfer rate it can support. During normal operation in the active state (L0), all lanes in a PCIe link are fully operational, allowing for maximum data throughput. In contrast, the low power standby states—L1, L2, and L3—are designed to reduce power consumption when the link is not actively transferring data. For example, in the L1 state some circuitry may remain powered for quicker recovery, but data transmission is halted. Unlike the L1, L2, and L3 states where data transmission is paused or significantly reduced, the L0p state allows the PCIe link to enter a power-saving mode without completely halting data transfer. This is achieved by maintaining at least one active lane for data transmission, ensuring that traffic flow is uninterrupted.

In PCIe technology, active state power management (ASPM) is aimed at reducing the power consumption of devices using PCIe connections. ASPM achieves energy efficiency by dynamically adjusting the power state of PCIe links based on active data transfer therethrough. This dynamic adjustment allows for a spectrum of power-saving modes, from minor reductions in power via decreased clock speeds (the L0s state) to more substantial power cuts by powering down the link entirely (transitioning into the L1, L2, or L3 states). This is particularly relevant in environments where the PCIe connected devices may not be constantly in use, allowing for significant power savings during periods of inactivity or low activity. However, the process of transitioning between active and low-power states introduces latency. This latency, incurred during the wake-up phase as PCIe devices return to a fully active state (L0) from a lower power state, can impact the performance of applications that are sensitive to delays. DL applications, known for their intensive data processing and transfer requirements, can be particularly affected by these delays. Due to the nature of DL workloads, which often require rapid, high-volume data exchanges between components, any added latency could potentially hinder application performance.

As such, conventional implementation of active state power management (ASPM) for power management in PCIe links may introduce several challenges that can affect PCIe connected device performance and energy efficiency. For instance, the transition to a standby state, such as L1, often depends on the historical idleness of the PCIe link, typically requiring a wait time of 100 μs to 400 μs or more. This process results in the PCIe link remaining in an active state for longer than necessary, thereby resulting in unnecessary energy expenditure. The process of exiting from a standby state to an active state is initiated by a real-time signal. Consequently, the latency associated with this transition can adversely affect performance of PCIe connected devices due to the delay in resuming full operational capabilities. The decision to transition to the L0p state is made based on a historical analysis of reduced load in the PCIe link, with typical durations ranging from 50 μs to 100 μs or more. This methodology leads to higher than necessary power consumption, as the link remains in an active state without substantial load. The strategy for transitioning between standby states, specifically from L1 to L2 and then to L3, aims to improve energy efficiency by relying on a history of PCIe link idleness. However, this approach can result in the PCIe link staying in the L3 state until the PCIe link is reactivated, which introduces significant latency upon resumption and potentially impacts responsiveness of PCIe connected devices. Adjustments to the PCIe link width are made based on the PCIe link's historical usage, leading to a scenario where the PCIe link may operate at wider widths than needed. This practice, however, can result in inefficient use of energy resources, as wider PCIe links consume more power.

Embodiments of the disclosure may leverage historical link usage information and predicted future link usage information associated with the PCIe link to dynamically adjust the L0p timers. For instance, if the predictions suggest an imminent decrease in link usage, the L0p timers can be shortened to allow quicker transitions to energy-saving states. Similarly, if an increase in usage is anticipated, the L0p timers can be shortened to allow quicker transitions to high performance states to accommodate the expected demand. In instances where the historical link usage information and predicted future link usage information conflict, the L0p timers may either be maintained at their default values or adjusted upwards, thereby extending the transition waiting time.

In addition, embodiments of the disclosure may leverage historical link usage information and predicted future link usage information associated with the PCIe link to adjust stand-by entrance timers. If predictions suggest an extended period of low or no traffic in the PCIe link, the standby entrance timers to transition to a lower state may be dynamically shortened. This allows the PCIe link to quickly enter a lower power state (e.g., L1, L2, L3), thereby saving energy during periods of inactivity. In some cases, the standby entrance timers to transition the PCIe link to a lower power state such as L2 or L3, beyond the L1 state, may be made based on the predicted duration of inactivity, ensuring that the PCIe link does not linger in the L1 state longer than necessary. As such, intermediate power states may be skipped in favor of transitioning directly to the most appropriate standby state. Conversely, if the predictions indicate that traffic will resume shortly, the current standby timer settings may be maintained or extended, ensuring that the PCIe link remains in a ready state.

Also, embodiments of the disclosure may leverage historical link usage information and predicted future link usage information associated with the PCIe link to implement an adaptive wake-up mechanism to preemptively wake a PCIe link from a deep sleep or idle state (e.g., the L3 state). In this regard, an earlier wake-up time for the PCIe link may be scheduled based on predictions indicating the duration of inactivity. In other words, embodiments of the disclosure may calculate an optimal wake-up time that precedes the actual need for the PCIe link based on the predicted idle duration. The goal is to find a middle ground for the wake-up timing that avoids the extremes of waking too early, which would negate energy savings, and waking at the time of signal arrival, which introduces latency. A wake-up that is slightly earlier than the time of signal arrival may ensure that the PCIe link is responsive without significantly impacting energy consumption.

The principles and methodologies described herein, while primarily articulated within the context of power state management for PCIe links, are not confined to this specific interface. It is expressly understood that the concepts of dynamic power management, including the predictive transitioning between various power states based on historical link usage information and predicted future link usage information, are applicable and extendable to a broad spectrum of signal conductor technologies and communication interfaces, such as NVLINK®, GRS, LPI, LLI, and/or the like. This adaptability is rooted in the nature of the underlying strategies, which focus on optimizing energy efficiency and performance through intelligent state transitions. Accordingly, the application of these principles to other link technologies shall be considered within the scope of this discourse, subject to modifications and adjustments as necessitated by the particular characteristics and requirements of each technology. Furthermore, the same principles of dynamic power management and predictive transitioning between power states are applicable to network devices such as NICs, switches, and other networking hardware that utilize such signal conductor technologies. The adaptability of these concepts allows for their effective implementation across a diverse array of network devices, enhancing energy efficiency and performance through intelligent state transitions.

Furthermore, embodiments of the disclosure may be applicable to any multi-lane interface exhibiting non-negligible idle power consumption and wake-up latency sensitivity. In particular, the link-state prediction mechanism may be applicable to various interfaces. In one embodiment, multi-lane die-to-die-based serializer-deserializer (SerDes) interfaces may be suitable candidates for implementing the disclosed methodology. In contrast, multi-lane chip-to-chip designs, such as C2C-LPI/LLI implementations utilized by NVIDIA, exhibit significantly lower idle power consumption, making them less suitable for this application. Additionally, in some embodiments, NVIDIA's CHI protocol running over die-to-die interfaces may benefit from the link-state prediction mechanism. Furthermore, embodiments of the disclosure may be applicable to multi-lane networking protocols, such as InfiniBand® and Ethernet. In such protocols, the prediction algorithm may be integrated with lane-width adjustment capabilities to optimize performance and energy efficiency.

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, “operatively coupled” may mean that the components are electronically or optically coupled and/or are in electrical or optical communication with one another. Furthermore, “operatively coupled” may mean that the components may be formed integrally with each other or may be formed separately and coupled together. Furthermore, “operatively coupled” may mean that the components may be directly connected to each other or may be connected to each other with one or more components (e.g., connectors) located between the components that are operatively coupled together. Furthermore, “operatively coupled” may mean that the components are detachable from each other or that they are permanently coupled together.

As used herein, “interconnected” may imply that each component is directly or indirectly linked to every other component or switch in the network, allowing for seamless data transfer and communication between all the components.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, satisfied, etc.

As used herein, “signal conductor” may refer to any medium or mechanism that facilitates the transmission of signals between components within a digital system. The term “link” may be used interchangeably with “signal conductor,” encompassing a variety of physical and logical connections that enable the exchange of information across different hardware elements.

It should be understood that the word “exemplary” is used herein to mean “serving as an example, instance, or illustration.” Any implementation described herein as “exemplary” is not necessarily to be construed as advantageous over other implementations.

Furthermore, as would be evident to one of ordinary skill in the art in light of the present disclosure, the terms “substantially” and “approximately” indicate that the referenced element or associated description is accurate to within applicable engineering tolerances.

### Example PCIe Based Interconnect Architecture

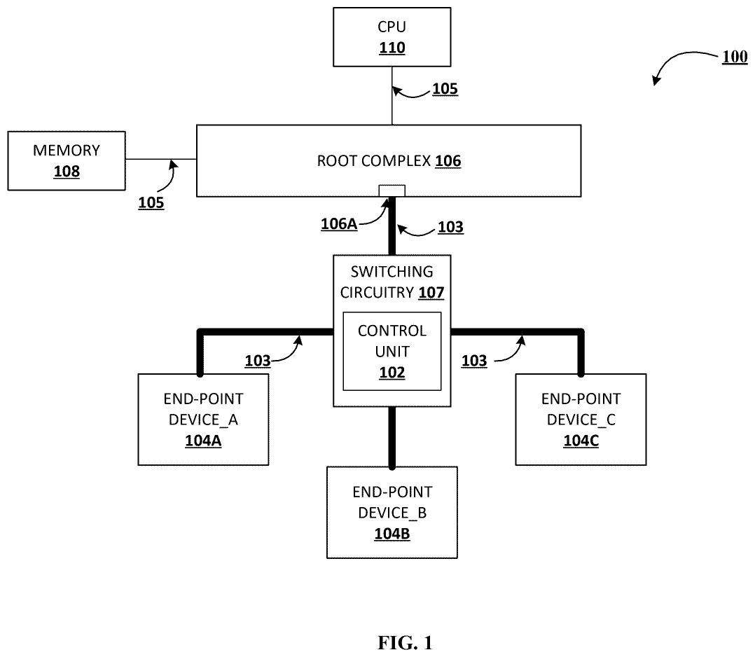

FIG. 1 illustrates an example PCIe-based interconnect architecture 100 for dynamic power management in signal conductors, in accordance with an embodiment of the present disclosure. In the context of the present disclosure, the PCIe-based interconnect architecture 100 may be configured to facilitate secure data transmission through a high-speed interconnect framework or fabric. Specifically, the PCIe-based interconnect architecture 100 may utilize a PCIe fabric, a serial computer expansion bus standard, to establish a network of devices (e.g., end-point devices as described in more detail herein) for the purpose of data communication. The architecture of the PCIe fabric offers a scalable, point-to-point topology enabling direct, secure signal conductors between end-point devices. Furthermore, the PCIe-based interconnect architecture 100, may be used in the operation of modern datacenters, facilitating high-speed, low-latency communication between key components such as CPUs, GPUs, and storage devices. The PCIe-based interconnect architecture 100 may support the infrastructure required for HPC tasks (e.g., DL tasks), where substantial data transfer between GPUs and other hardware components may be necessary.

FIG. 1 illustrates only one example of an embodiment of the PCIe-based interconnect architecture 100, and it will be appreciated that in other embodiments one or more of the systems, units, and/or devices may be combined into a single system, unit, or device or be made up of multiple systems, units, or devices. Furthermore, it is to be understood that reference to the PCIe fabric is illustrative rather than prescriptive. The PCIe-based interconnect architecture 100 described need not be limited to PCIe fabric and can accommodate alternative high-speed interconnect technologies. In such cases, the configuration of the PCIe-based interconnect architecture 100 may be modified to meet the specific requirements of any chosen high-speed interconnect technology.

As shown in FIG. 1, the PCIe-based interconnect architecture 100 may include a switching circuitry 107, a plurality of end-point devices 104A, 104B, 104C, a root complex 106, a root port 106A, a CPU 110, and a memory 108.

The plurality of end-point devices 104A, 104B, 104C may refer to devices that act as terminal points of communication within the PCIe fabric. As such, the plurality of end-point devices 104A, 104B, 104C may be peripheral devices that are being connected to the system, such as network cards, GPUs, NICs, storage controllers/adapters, field programmable gate array (FPGA) accelerators, sound cards/audio interfaces, artificial intelligence (AI)/machine learning (ML) accelerators, and/or the like.

The root complex 106 may be a primary interface within the PCIe fabric that is used to connect peripheral devices, such as the plurality of end-point devices 104A, 104B, 104C and the switching circuitry 107, to the PCIe fabric. The root complex 106 may be configured to manage the communication between external components, such as the CPU 110, memory 108, and/or the like, and the peripheral devices. These external components may be operatively coupled to the root complex 106 via buses 105. The root complex 106 may include root ports, such as root port 106A to interface with the peripheral devices, manage a configuration for discovering and configuring peripheral devices, and manage data paths for routing data between the external components and the peripheral devices.

The switching circuitry 107 may refer to a switching device within the PCIe fabric, which can route data between different points in the PCIe-based interconnect architecture 100, including between multiple end-point devices 104A, 104B, 104C and the root complex 106. In this regard, the plurality of end-point devices 104A, 104B, 104C, the switching circuitry 107, and the root complex 106 may be operatively coupled via signal conductors 103. The signal conductors 103 may be high-speed interconnects, facilitating data transfer and communication between the end-point devices 104A, 104B, 104C, the switching circuitry 107, and the root complex 106. Specifically, the signal conductors 103 may be implemented as PCIe links, a standard for serial expansion buses and devices. As described herein, the PCIe specification may include various low power standby states—L1, L2, and L3—that are designed to regulate power consumption in end-point devices (e.g., end-point devices 104A, 104B, 104C) operatively coupled via PCIe links (e.g., signal conductors 103). These states may represent a graduated scale of power-saving modes in contrast with the active state, L0—a higher power usage.

Additionally, integrated within the switching circuitry 107 is a control unit 102. The control unit 102 may be configured to capture, and subsequently utilize, bandwidth usage pattern information and predictions regarding future bandwidth usage on the PCIe link to dynamically adjust the timers associated with power-state transitions. By dynamically adjusting the timers, the control unit 102 may allow for quicker transitions to energy-saving states or maintenance in higher performance states based on anticipated bandwidth usage changes. The control unit 102 may further be configured to adjust the standby entrance timers based on similar predictive and historical bandwidth usage data, allowing for more efficient transitions into and out of low power states, such as L1, L2, or L3, depending on the expected period of inactivity. Additionally, the control unit 102 may be configured to implement an adaptive wake-up mechanism for the signal conductors 103 from idle states, such as the L3 state, scheduling wake-ups based on the predicted duration of inactivity to balance the need for responsiveness with energy conservation.

It should be noted that the implementation of the control unit 102 is not restricted to the switching circuitry 107. The PCIe-based interconnect architecture 100 allows for the control unit 102, or portions of its functionality, to be located within other components of the PCIe-based interconnect architecture 100, such as the end-point devices 104A, 104B, 104C, the root complex 106, and/or the like, distributing various functions of the control unit 102 among various system components. Each component, such as an end-point device 104A, 104B, 104C, may contain a part of the control unit 102 or may have its hardware configured to perform specific operations of the control unit 102. This distributive capability of the control unit's functions ensures that dynamic power management can be effectively implemented throughout the PCIe-based interconnect architecture 100, optimizing energy efficiency and system performance.

It is to be understood that the structure of the PCIe-based interconnect architecture 100 and its components, connections and relationships, and their functions, are meant to be exemplary only, and are not meant to limit implementations of the disclosures described and/or claimed in this document. In one example, the PCIe-based interconnect architecture 100 may include more, fewer, or different components. In another example, some or all of the portions of the PCIe-based interconnect architecture 100 may be combined into a single portion or all of the portions of the environment 100 may be separated into two or more distinct portions.

### Example End-point Device Circuitry

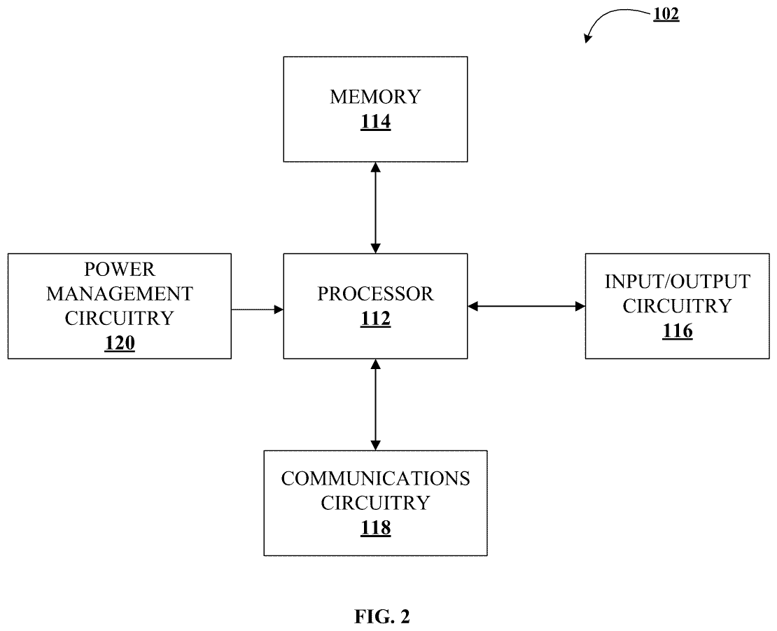

FIG. 2 illustrates example control unit circuitry 102 for dynamic power management in signal conductors, in accordance with an embodiment of the present disclosure. As shown in FIG. 2, the control unit 102 may include a processor 112, a memory 114, input/output circuitry 116, communications circuitry 118, and power management circuitry 120.

Although the term “circuitry” as used herein with respect to components 112-120 is described in some cases using functional language, it should be understood that the particular implementations necessarily include the use of particular hardware configured to perform the functions associated with the respective circuitry as described herein. It should also be understood that certain of these components 112-120 may include similar or common hardware. For example, two sets of circuitries may both leverage use of the same processor, network interface, storage medium, or the like to perform their associated functions, such that duplicate hardware is not required for each set of circuitries. It will be understood in this regard that some of the components described in connection with the control unit 102 may be housed together, while other components are housed separately (e.g., a controller in communication with the control unit 102). While the term “circuitry” should be understood broadly to include hardware, in some embodiments, the term “circuitry” may also include software for configuring the hardware. For example, in some embodiments, “circuitry” may include processing circuitry, storage media, network interfaces, input/output devices, and the like. In some embodiments, other elements of the control unit 102 may provide or supplement the functionality of particular circuitry. For example, the processor 112 may provide processing functionality, the memory 114 may provide storage functionality, the communications circuitry 118 may provide network interface functionality, and the like.

In some embodiments, the processor 112 (and/or co-processor or any other processing circuitry assisting or otherwise associated with the processor) may be in communication with the memory 114 via a bus for passing information among components of, for example, the control unit 102. The memory 114 may be non-transitory and may include, for example, one or more volatile and/or non-volatile memories, or some combination thereof. In other words, for example, the memory 114 may be an electronic storage device (e.g., a non-transitory computer readable storage medium). The memory 114 may be configured to store information, data, content, applications, instructions, or the like, for enabling an apparatus, e.g., the control unit 102, to carry out various functions in accordance with example embodiments of the present disclosure.

Although illustrated in FIG. 2 as a single memory, the memory 114 may comprise a plurality of memory components. The plurality of memory components may be embodied on a single computing device or distributed across a plurality of computing devices. In various embodiments, the memory 114 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 114 may be configured to store information, data, applications, instructions, or the like for enabling the control unit 102 to carry out various functions in accordance with example embodiments discussed herein. For example, in at least some embodiments, the memory 114 may be configured to buffer data for processing by the processor 112. Additionally, or alternatively, in at least some embodiments, the memory 114 may be configured to store program instructions for execution by the processor 112. The memory 114 may store information in the form of static and/or dynamic information. This stored information may be stored and/or used by the control unit 102 during the course of performing its functionalities.

The processor 112 may be embodied in a number of different ways and may, for example, include one or more processing devices configured to perform independently. Additionally, or alternatively, the processor 112 may include one or more processors configured in tandem via a bus to enable independent execution of instructions, pipelining, and/or multithreading. The processor 112 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an application specific integrated circuit (ASIC) or field programmable gate array (FPGA), or some combination thereof. The use of the term “processing circuitry” may be understood to include a single core processor, a multi-core processor, multiple processors internal to the apparatus, and/or remote or “cloud” processors. Accordingly, although illustrated in FIG. 2 as a single processor, in some embodiments, the processor 112 may include a plurality of processors. The plurality of processors may be embodied on a single computing device or may be distributed across a plurality of such devices collectively configured to function as the control unit 102. The plurality of processors may be in operative communication with each other and may be collectively configured to perform one or more functionalities of the control unit 102 as described herein.

In an example embodiment, the processor 112 may be configured to execute instructions stored in the memory 114 or otherwise accessible to the processor 112. Alternatively, or additionally, the processor 112 may be configured to execute hard-coded functionality. As such, whether configured by hardware or software methods, or by a combination thereof, the processor 112 may represent an entity (e.g., physically embodied in circuitry) capable of performing operations according to an embodiment of the present disclosure while configured accordingly. Alternatively, as another example, when the processor 112 is embodied as an executor of software instructions, the instructions may specifically configure the processor 112 to perform one or more algorithms and/or operations described herein when the instructions are executed. For example, these instructions, when executed by the processor 112, may cause the control unit 102 to perform one or more of the functionalities thereof as described herein.

In some embodiments, the control unit 102 may further include input/output circuitry 116 that may, in turn, be in communication with the processor 112 to provide an audible, visual, mechanical, or other output and/or, in some embodiments, to receive an indication of an input from a user or another source. In that sense, the input/output circuitry 116 may include means for performing analog-to-digital and/or digital-to-analog data conversions. The input/output circuitry 116 may include support, for example, for a display, touchscreen, keyboard, mouse, image capturing device (e.g., a camera), microphone, and/or other input/output mechanisms. The input/output circuitry 116 may include a user interface and may include a web user interface, a mobile application, a kiosk, or the like.

The processor 112 and/or user interface circuitry comprising the processor 112 may be configured to control one or more functions of a display or one or more user interface elements through computer-program instructions (e.g., software and/or firmware) stored on a memory accessible to the processor 112 (e.g., the memory 114, and/or the like). In some embodiments, aspects of input/output circuitry 116 may be reduced as compared to embodiments where the control unit 102 may be implemented as an end-user machine or other type of device designed for complex user interactions. In some embodiments (like other components discussed herein), the input/output circuitry 116 may be eliminated from the control unit 102. The input/output circuitry 116 may be in communication with memory 114, communications circuitry 118, and/or any other component(s), such as via a bus. Although more than one input/output circuitry and/or other component can be included in the control unit 102, only one is shown in FIG. 2 to avoid overcomplicating the disclosure (e.g., as with the other components discussed herein).

The communications circuitry 118, in some embodiments, includes any means, such as a device or circuitry embodied in either hardware, software, firmware or a combination of hardware, software, and/or firmware, that is configured to receive and/or transmit data from/to a network and/or any other device, circuitry, or module associated therewith. In this regard, the communications circuitry 118 may include, for example, a network interface for enabling communications with a wired or wireless communication network. For example, in some embodiments, communications circuitry 118 may be configured to receive and/or transmit any data that may be stored by the memory 114 using any protocol that may be used for communications between computing devices. For example, the communications circuitry 118 may include one or more communication ports, NICs, antennae, transmitters, receivers, buses, switches, routers, modems, and supporting hardware and/or software, and/or firmware/software, or any other device suitable for enabling communications via a network. Additionally, or alternatively, in some embodiments, the communications circuitry 118 may include circuitry for interacting with the antenna(s) to cause transmission of signals via the antenna(e) or to handle receipt of signals received via the antenna(e). These signals may be transmitted by the control unit 102 using any of a number of wireless personal area network (PAN) technologies, such as Bluetooth® v1.0 through v5.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. The communications circuitry 118 may additionally or alternatively be in communication with the memory 114, the input/output circuitry 116, and/or any other component of the control unit 102, such as via a bus. The communication circuitry 118 of the control unit 102 may also be configured to receive and transmit information to and from the various components associated therewith.

The power management circuitry 120 may be configured to execute the dynamic power management operations within the control unit 102. In this regard, the power management circuitry 120 may be configured to regulate the transition times associated with the power states of the signal conductors 103 based on real-time and predictive data analysis regarding bandwidth usage. In an example embodiment, the power management circuitry 120 may be configured to adjust L0p timers to facilitate rapid transitions between various power states, enhancing energy efficiency during periods of fluctuating demand. For instance, if the predictions suggest an imminent decrease in bandwidth usage, the power management circuitry 120 may be configured to shorten the L0p timers to allow quicker transitions to energy-saving states. Moreover, the power management circuitry 120 may be configured to modify standby entrance timers, leveraging bandwidth usage predictions to optimize the timing for transitions into lower power states. In addition, the power management circuitry 120 may be configured to manage an adaptive wake-up mechanism, scheduling the preemptive activation of the signal conductors 103 from deeper sleep states based on forecasted inactivity durations.

In some embodiments, the control unit 102 may include hardware, software, firmware, and/or a combination of such components, configured to support various aspects of power management circuitry as described herein. It should be appreciated that in some embodiments, the power management circuitry 120 may perform one or more of such example actions in combination with another circuitry of the control unit 102, such as the memory 114, processor 112, input/output circuitry 116, and/or communications circuitry 118. For example, in some embodiments, the power management circuitry 120 may utilize the processing circuitry, such as the processor 112 and/or the like, to form a self-contained subsystem to perform one or more of its corresponding operations. In a further example, and in some embodiments, some or all of the functionality of the power management circuitry 120 may be performed by the processor 112. In this regard, some or all of the example processes and algorithms discussed herein can be performed by at least one of the processor 112 and the power management circuitry 120. It should also be appreciated that, in some embodiments, the power management circuitry 120 may include a separate processor, specially configured FPGA, or ASIC to perform its corresponding functions.

Additionally, or alternatively, in some embodiments, the power management circuitry 120 may use the memory 114 to store collected information. For example, in some implementations, the power management circuitry 120 may include hardware, software, firmware, and/or a combination thereof, that interacts with the memory 114 to send, retrieve, update, and/or store data.

Accordingly, non-transitory computer readable storage media, which may, for example, be the memory 114, can be configured to store firmware, one or more application programs, and/or other software, which includes instructions and/or other computer-readable program code portions that can be executed to direct operation of the control unit 102 to implement various operations, including the examples described herein. As such, a series of computer-readable program code portions may be embodied in one or more computer-program products and can be used, with a device, control unit 102, database, and/or other programmable apparatus, to produce the machine-implemented processes discussed herein. It is also noted that all or some of the information discussed herein can be based on data that is received, generated and/or maintained by one or more components of the control unit 102. In some embodiments, one or more external systems (such as a remote cloud computing and/or data storage system) may also be leveraged to provide at least some of the functionality discussed herein.

It should be recognized that the structure of the control unit 102, as detailed herein, represents merely one embodiment among a multitude of potential configurations. This particular structure of the control unit 102 is described to demonstrate a specific arrangement and interaction of its components—encompassing data processing units, network interfaces, and power management circuitry—that collectively contribute to its comprehensive network capabilities. However, this outlined configuration is not definitive or limiting. The structure of the control unit 102 and its integral components can be varied to adapt to different networking paradigms, technological evolutions, and specific application needs. Alternative embodiments of the control unit 102 might employ varying types of processors, such as advanced multi-core CPUs or specialized GPUs, distinct networking interfaces like SmartNICs or advanced wireless modules, and diverse methods for managing network events and communications. Moreover, the scalability, data handling techniques, and network integration approaches of the control unit 102 can substantially differ based on targeted operational environments and functional requisites. Thus, while the present disclosure depicts one potential structure for the control unit 102, it is to be understood that this represents just one exemplification within the broader realm of network-enabled devices. The scope of the disclosure is, therefore, not confined to this singular form but is extendable to various other forms, technologies, and configurations.

### Example Computing System

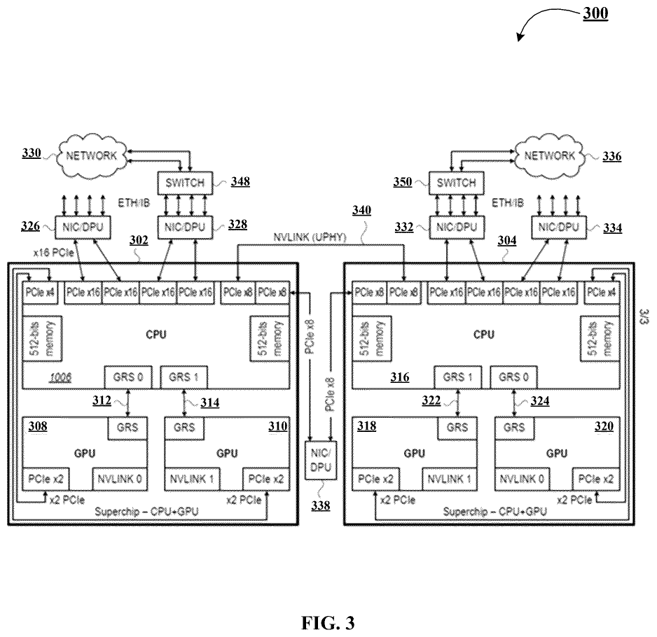

FIG. 3 is a block diagram that illustrates a computing system 300, such as a datacenter environment or a HPC cluster, in accordance with an embodiment described herein. System 300 may include multiple subsystems, such as processing devices, network devices, and interconnected networks, according to at least one embodiment. Computing system 300 may comprise multiple integrated circuits (referred to as processing devices), where each integrated circuit may include one or more CPUs and GPUs, providing a flexible architecture.

The processing devices may be interconnected via an NVLink® or other high-speed interconnect, allowing for communication between the subsystems. Additionally, processing devices may connect to the system's networks through NICs or DPUs to facilitate data transfer across computing system 300 and to one or more external networks 330, 336. System 300 may include a packet switch 348 that connects NIC/DPU 328 to network 330 and a packet switch 350 that connects NIC/DPU 332 to network 336.

The configuration of processing devices with NVLink® interconnections may support parallel processing, which may improve computational efficiency. Processing devices may connect to multiple networks through one or more NICs or DPUs, enabling the system to manage complex, multi-network tasks with high bandwidth and low latency. This configuration may be suitable for applications requiring significant processing resources, such as artificial intelligence (AI), machine learning (ML), and data-intensive computing, while maintaining connectivity and scalability across networked environments. Integrated circuits in computing system 300 may include one or more CPUs and one or more GPUs.

FIG. 3 also demonstrates a multi-GPU architecture. In this embodiment, computing system 300 may include a processing device 302 with a multi-GPU architecture. Processing device 302 may be a system-on-chip (SoC) with subsystems such as CPU 306, GPU 308, and GPU 310. CPU 306 may be connected to GPU 308 via a die-to-die (D2D) or chip-to-chip (C2C) interconnect 312, such as a GRS interconnect, and to GPU 310 via a D2D or C2C interconnect 314. CPU 306 may also be connected to GPU 308 and GPU 310 via PCIe interconnects.

CPU 306 may connect to one or more NICs or DPUs, which may be further connected to networks. For instance, as shown in FIG. 3, CPU 306 may connect to NIC/DPU 326, which may link to network 330, and to NIC/DPU 328, which may also connect to network 330 via switch 348. NIC/DPU 326 and NIC/DPU 328 may connect to network 330 over Ethernet (ETH), NVLink®, or InfiniBand® (IB) connections.

Computing system 300 may further include a processing device 304 with a multi-GPU architecture. Processing device 304 may include subsystems such as CPU 316, GPU 318, and GPU 320. CPU 316 may be connected to GPU 318 via D2D or C2C interconnect 322 and to GPU 320 via D2D or C2C interconnect 324. CPU 316 may also be connected to GPU 318 and GPU 320 via PCIe interconnects. CPU 316 may connect to one or more NICs or DPUs, which may be coupled to networks. As illustrated, CPU 316 may connect to NIC/DPU 332, which may link to network 336, and NIC/DPU 334, which may connect to network 336 via switch 350. NIC/DPU 332 and NIC/DPU 334 may connect to network 336 over Ethernet (ETH), NVLink®, or InfiniBand® (IB) connections.

In at least one embodiment, processing devices 302 and 304 may communicate via NIC/DPU 338, such as over PCIe interconnects, or through high-bandwidth communication interconnects 340, such as an NVLink® interconnect. The packet switches in FIG. 3 may include Nvidia® Quantum-2 switches, while the NICs/DPUs may include Nvidia® Bluefield® DPUs.

Within this datacenter or HPC cluster, embodiments of the disclosure enable dynamic power management of PCIe links by leveraging both historical and predicted link usage data to optimize power state transitions. In this regard, the control unit (e.g., control unit 102) may be integrated within the switching circuitry (such as packet switches 348 and 350) or directly embedded in one or more of the processing devices (e.g., processing devices 302 or 304). The control unit may be configured to manage dynamic power adjustments across PCIe links and coordinates the transition of signal conductors between power states based on real-time usage data and predictive modeling. The control unit may capture and analyze historical link usage patterns and forecasted data, enabling rapid adjustments to transition times associated with each power state, such as L0, L0p, L1, L2, and L3.

The control unit 102 may also be distributed across different components within system 300, including NICs, DPUs, or even individual GPUs, to ensure that power management operations are efficiently executed in real-time. This decentralized configuration allows the control unit to dynamically adjust power states for inter-device PCIe links—such as those connecting processing devices 302 and 304 to networks 330 and 336 via NICs/DPUs 326, 328, 332, and 334—based on workload requirements, minimizing latency and energy consumption across the datacenter or HPC cluster. Through this strategic positioning within system 300, control unit may be configured to effectively balance performance and power efficiency, particularly in applications with fluctuating computational demands like deep learning and data-intensive processing.

As described herein, the control unit may analyze real-time and predictive data on bandwidth usage patterns to adjust the power states of the PCIe links, optimizing energy efficiency without compromising data transfer performance. For instance, the control unit may dynamically reduce the power state of a PCIe link when data flow predictions suggest reduced activity between devices, thereby decreasing power consumption in periods of low usage. Moreover, the control unit can facilitate transitions into and out of standby states, such as L1, L2, or L3, depending on the predicted traffic requirements of each device pair connected via the PCIe links. By implementing adaptive wake-up mechanisms, the control unit can preemptively wake links from deep sleep states (e.g., L3) to ensure devices are ready for data transfer upon demand, thus reducing latency for data-intensive applications like Deep Learning (DL) workloads. This approach is particularly beneficial in datacenter environments where rapid data exchange and power efficiency are essential for scalable high-performance computing.

It is to be understood that the embodiments and configurations described herein are provided solely for illustrative purposes and are not intended to limit the scope of the disclosure. Various modifications, adaptations, and alternative implementations will become apparent to those skilled in the art without departing from the broader scope and spirit of the disclosure as set forth in the claims. Specific components, configurations, or functionalities referenced, such as particular processing devices, interconnect technologies, or power states, may be substituted or modified to suit differing applications, technological advances, or system requirements. The principles and techniques described herein are intended to apply broadly to various signal conductor technologies, network configurations, and datacenter architectures, including but not limited to those specifically exemplified.

### Example Method for Dynamic Power Management in Signal Conductors

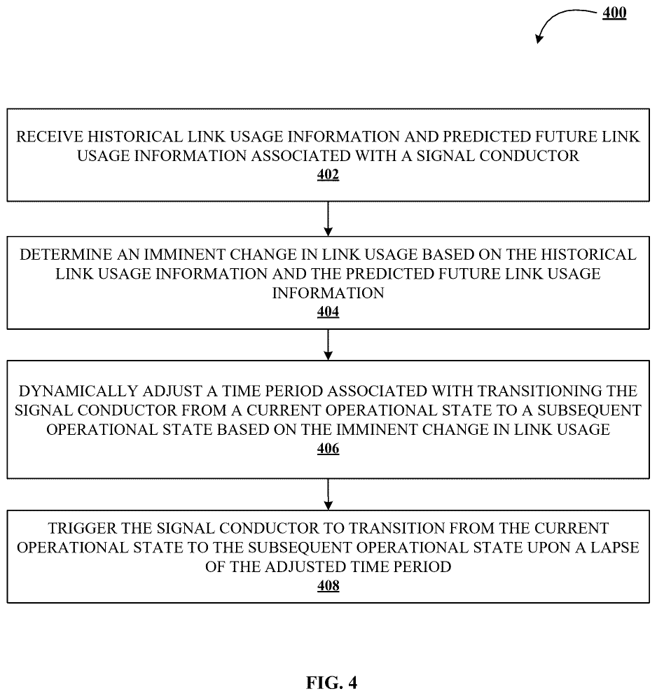

FIG. 4 illustrates an example method 400 for dynamic power management in signal conductors. In accordance with an embodiment of the disclosure. As shown in block 402, historical link usage information and predicted future link usage information associated with a signal conductor is received. Historical link usage information may include a dataset comprising records of past activity on the signal conductor (e.g., PCIe link). This dataset may include metrics such as data transfer rates, frequency of use, duration of activity, patterns of data flow observed over a defined historical period, and/or the like. The purpose of analyzing historical data is to identify trends and patterns in link usage, which can inform the development of strategies for performance optimization. Predicted future link usage information may include forecasts of link activity based on a combination of historical data. The predicted future link usage information may anticipate future states of link usage, including expected periods of high demand, low activity, or idleness. The prediction methodologies may incorporate algorithms, machine learning models, or statistical analysis to project future usage patterns. The details of the predictive methods and algorithms utilized for forecasting future link usage are described in a related patent application titled, “Predicting Inactivity Patterns for a Signal Conductor,” U.S. patent application Ser. No. 17/893,692, which is incorporated by reference herein.

As shown in block 404, an imminent change in link usage is determined based on the historical link usage information and the predicted future link usage information received. An imminent change in link usage may include an anticipated increase or decrease in link activity in the near term. As described herein, historical link usage information may include records of past link activities. Analysis of this information allows for the identification of established trends and regularities in link usage. Predicted future link usage information, on the other hand, aim to project future states of link activity, identifying potential increases or decreases in demand. For an ideal determination, the analysis of historical link usage information should independently suggest the same imminent change in link usage as indicated by the predicted future link usage information. For instance, if historical trends show a cyclical increase in link usage around certain periods, and predictive models, considering additional variables, also forecast an increase in activity for the upcoming period, both sources corroborate the anticipation of increased link activity. However, it is not uncommon for the historical link usage information and the predicted future link usage information to not align in their indication of the same change in activity. This may be due to a number of unforeseen reasons such as sudden shifts in demand, data anomalies in past events, evolution of usage patterns, model sensitivity, and/or the like.

As shown in block 406, a time period associated with transitioning the signal conductor from a current operational state to a subsequent operational state is dynamically adjusted based on the imminent change in link usage. As described herein, the operational states (e.g., current operational state, subsequent operational state, and/or the like) may be defined within a framework of power management states for PCIe links that are designed to optimize the balance between energy efficiency and performance. These states, known as the L-states, may be defined as a sequence of operational power states range from high performance to low power consumption. For instance, in the fully operational L0 state, the PCIe link is active and capable of maximum performance, facilitating data transfers at the highest rate supported by the hardware. Power consumption is at its peak in the L0 state due to the high level of activity. In the low-power states, L1, L2, and L3, the PCIe link is non-active, providing various levels of power savings. Transitioning from any of these low-power states back to the fully active L0 state involves varying durations of recovery time depending on the specific low-power state from which the transition originates. In addition, in a slight reduction from the L0 state, L0p is a low-power idle state that allows for quick recovery back to L0. The transition times to and from L0s are short, making L0p suitable for brief periods of inactivity.

The time period may refer to the duration required for the PCIe link to transition between specified power states, such as from a low-power state (e.g., L1, L2, L3) to an active state (L0, L0p), or vice versa. This duration may impact the readiness of the PCIe link to commence, resume, reduce, or cease data transmissions. Optimally adjusting these transition times based on actual and anticipated link usage patterns enables the system to dynamically align its operational efficiency and performance capabilities with current and expected demands, thereby avoiding unnecessary power consumption or performance degradation.

In the context of a datacenter, PCIe-connected devices such as GPUs and NICs often balance high performance with the need for power efficiency. The power-saving states outlined in the PCIe specification (L1, L2, L3, and L0p) provide a framework for reducing energy consumption. For instance, the L1 state reduces power usage while maintaining the ability to quickly resume full operation, ideal for workloads that experience intermittent bursts of high demand. The deeper L3 state, while providing maximum power savings, may introduce latency, which could impact the performance of latency-sensitive DL applications.

As shown in block 408, the signal conductor is triggered to transition from the current operational state to the subsequent operational state upon a lapse of the adjusted time period. In one example, the PCIe link may be in a semi-active L0p state, where the PCIe link is maintained in an operational but lower power mode. If the imminent change in link usage is a decreased link usage when the PCIe link is in the L0p state, then the PCIe link may transition into a low-power state, such as the L1 state. However, the transition to the L1 state in conventional systems often requires a wait of 100 μs to 400 μs or more, resulting in the PCIe link remaining in an active state for longer than necessary, thereby increasing energy expenditure without direct need. As such, to avoid unnecessary power consumption, the embodiments of the system (e.g., the control unit 102 in FIG. 2) may be configured to reduce the transition period (e.g., to around 10 μs to 50 μs or less) and trigger the PCIe link to transition at the lapse of the reduced transition period. On the other hand, if the imminent change in link usage is an increased link usage when the PCIe link is in the L0p state, then the PCIe link may transition into an active L0 state. Similarly, the system may reduce the transition (e.g., to 10 μs to 50 μs or less), and trigger the PCIe link to transition at the lapse of the reduced transition period.

As described herein, in an optimal scenario, the analysis of historical link usage information aligns with the indications from predicted future link usage information, both suggesting an imminent change in link usage (e.g., increase, decrease, no-change, and/or the like). However, in instances in which the historical link usage information and the predicted link usage information provide conflicting indications regarding the imminent change in link usage, the system may dynamically increase the transition period. Increasing the transition period may serve as a safeguard, providing an opportunity for any sudden shifts in demand, data anomalies, evolution of usage patterns, model sensitivity, and/or the like to naturally resolve without triggering the transition of the PCIe link prematurely. Alternatively or additionally, in instances in which the historical link usage information and the predicted link usage information provide conflicting indications regarding the imminent change in link usage, the system may reset the transition period to a predetermined default value.

In example embodiments, the imminent change in link usage may be an imminent duration of inactivity in the PCIe link. In such instances, the system may transition the PCIe link from an active operational state (e.g., L0) or semi-active operational state (e.g., L0p) into a low-power operational state (e.g., L1, L2, L3). However, as described herein, the transition to a low-power operational state often requires a specific transition period (e.g., 100 μs to 400 μs or more), resulting in the PCIe link remaining in an active or semi-active operational state for longer than necessary. If the imminent change is a duration of inactivity (e.g., a period of low or no traffic) in the PCIe link, the system may reduce the transition period (e.g., to 10 μs to 50 μs or less), and trigger the PCIe link to transition at the lapse of the reduced transition period. In one example, if the PCIe link is currently in an active operational state (e.g., L0), and if the duration of inactivity is a relatively short period of no traffic, then the system may reduce the transition period to transition the PCIe link from L0 to a subsequent semi-active operational state (e.g., L0p) at the lapse of the reduced time period. In another example, if the PCIe link is currently in a semi-active operational state (e.g., L0p), and if the duration of inactivity is a relatively short period of no traffic, then the system may reduce the transition period to transition the PCIe link from L0p to a subsequent low-power operational state (e.g., L1) at the lapse of the reduced time period. In yet another example, if the PCIe link is currently in an active operational state (e.g., L0), and if the duration of inactivity is an extended period of no traffic, then the system may reduce the transition period to transition the PCIe link from L0 to the low-power state L3 (e.g., the terminal state in the sequence of operational power states of the PCIe link) directly at the lapse of the reduced time period, without a gradual stepwise transition through available low-power states.

In example embodiments, the imminent change in link usage may be an increased link usage. In such instances, the system may transition the PCIe link from a low-power operational state (e.g., L1, L2, L3) or a semi-active operational state (e.g., L0p), to an active operational state (e.g., L0). However, the standard transition time required for the PCIe link to adjust from a low-power operational state to an active operational state can introduce operational inefficiencies. Specifically, peripheral devices, such as GPUs, that depend on the PCIe link for data acquisition, may experience latency. This latency arises because the peripheral device often waits for the duration of the transition time before it can access the necessary data via the PCIe link. Consequently, this waiting period can contribute to additional delays in the processing of tasks, potentially impacting overall system performance and the timely execution of functions that rely on rapid data access and processing capabilities. As such, when the imminent change in link usage is an increased link usage, the system may reduce the transition period for the PCIe link to transition from a low-power operational state (e.g., L2) to an active operational state (e.g., L0), and trigger the PCIe link to transition to the active operational state at the lapse of the reduced transition period prior to the increased link usage.

Alternatively or additionally, in some embodiments, the control unit may be configured to directly trigger the signal conductor to transition from its current operational state to a subsequent operational state upon detecting an imminent change in link usage. This approach eliminates the need for timer-based adjustments, thereby allowing for instantaneous state transitions in response to dynamic usage conditions. This method could potentially enhance the responsiveness of the PCIe link to fluctuating demands while simplifying the control architecture by removing the reliance on pre-configured timer settings.

By leveraging historical link usage data and predictive analysis, embodiments of the disclosure can dynamically adjust the transition timers for PCIe power states in a datacenter environment. Such a predictive mechanism allows the system to anticipate when high workloads are expected and keep the system in a high-performance state (e.g., L0 or L0p), while transitioning to lower power states (e.g., L1, L2, or L3) during periods of inactivity. This approach may not only save energy but also minimize latency by preemptively waking the system from deeper power states based on predicted demand.

The principles of dynamic power management outlined in various embodiments of this disclosure are not limited to PCIe-connected devices but are broadly applicable to various signal conductor technologies and networking components within a datacenter. This may include NICs, switches, and other network devices in modern datacenters. By intelligently transitioning between power states based on anticipated workloads, the embodiments of the disclosure may improve both energy efficiency and performance across the entire datacenter infrastructure.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases the method may include additional steps. The steps and modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for dynamic power management in signal conductors, the system comprising:
a signal conductor;
a control unit operatively coupled to the signal conductor, wherein the control unit is configured to:
receive historical link usage information and predicted future link usage information associated with the signal conductor;
determine an imminent change in link usage based on the historical link usage information and the predicted future link usage information received; and
trigger the signal conductor to transition from a current operational state to a subsequent operational state in response to determining the imminent change.

2. The system of claim 1, wherein the control unit is further configured to:
dynamically adjust a time period associated with transitioning the signal conductor from the current operational state to the subsequent operational state based on the imminent change in link usage, wherein the current operational state and the subsequent operational state are defined in a sequence of operational power states; and
trigger the signal conductor to transition from the current operational state to the subsequent operational state upon a lapse of the adjusted time period.

3. The system of claim 2, wherein the imminent change in link usage is a decreased link usage, wherein the control unit is configured to dynamically adjust the time period by reducing the time period, and wherein the subsequent operational state is a low-power state immediately succeeding the current operational state in the defined sequence of operational power states.

4. The system of claim 2, wherein the imminent change in link usage is an increased link usage, wherein the control unit is configured to dynamically adjust the time period by reducing the time period, and wherein the subsequent operational state is a high-power state immediately preceding the current operational state in the defined sequence of operational power states.

5. The system of claim 2, wherein in an instance in which the historical link usage information and the predicted link usage information provide conflicting indications regarding the imminent change in link usage, the control unit is configured to dynamically adjust the time period by increasing the time period.

6. The system of claim 5, wherein the control unit is configured to:
reset the time period associated with transitioning the signal conductor from the current operational state the subsequent operational state to a default value.

7. The system of claim 2, wherein the control unit is configured to determine an imminent duration of inactivity in the signal conductor based on the historical link usage information and the predicted link usage information,
wherein, in an instance in which the imminent duration of inactivity is determined, the control unit is configured to dynamically adjust the time period by reducing the time period, and
wherein the subsequent operational state is a low-power operational state.

8. The system of claim 7, wherein the low-power operational state is a terminal state in the defined sequence of operational power states.

9. The system of claim 7, wherein the low-power operational state immediately succeeds the current operational state in the defined sequence of operational power states.

10. The system of claim 2, wherein:
the current operational state is a low-power operational state,
the imminent change in link usage is an increased link usage,
wherein the control unit is further configured to dynamically adjust the time period by reducing the time period,
the subsequent operational state is an active power operational state in the defined sequence of operational power states; and
the control unit is configured to trigger the signal conductor to transition from the current operational state to the subsequent operational state such that the signal conductor is in the subsequent operational state prior to the increased link usage.

11. The system of claim 10, wherein the active power operational state is an initial state in the defined sequence of operational power states.

12. The system of claim 2, wherein the signal conductor is a peripheral component interconnect express (PCIe) link, and wherein the defined sequence of operational power states comprises L0, L0p, L1, L2, and L3 power states.

13. A method for dynamic power management in signal conductors, the method comprising:
receiving historical link usage information and predicted future link usage information associated with a signal conductor;
determining an imminent change in link usage based on the historical link usage information and the predicted future link usage information; and
triggering the signal conductor to transition from a current operational state to a subsequent operational state in response to determining the imminent change.

14. The method of claim 13, further comprising:
dynamically adjusting a time period associated with transitioning the signal conductor from the current operational state to the subsequent operational state based on the imminent change in link usage, wherein the current operational state and the subsequent operational state are defined in a sequence of operational power states; and
triggering the signal conductor to transition from the current operational state to the subsequent operational state upon a lapse of the adjusted time period.

15. The method of claim 14, wherein the imminent change in link usage is a decreased link usage, wherein dynamically adjusting the time period comprises reducing the time period, and wherein the subsequent operational state is a low-power state immediately succeeding the current operational state in the defined sequence of operational power states.

16. The method of claim 14, wherein the imminent change in link usage is an increased link usage, wherein dynamically adjusting the time period comprises reducing the time period, and wherein the subsequent operational state is a high-power state immediately preceding the current operational state in the defined sequence of operational power states.

17. The method of claim 14, wherein in an instance in which the historical link usage information and the predicted link usage information provide conflicting indications regarding the imminent change in link usage, dynamically adjusting the time period comprises increasing the time period.

18. The method of claim 17, further comprising:
resetting the time period associated with transitioning the signal conductor from the current operational state to the subsequent operational state to a default value.

19. A computer program product for dynamic power management in signal conductors, the computer program product comprising a non-transitory computer-readable medium comprising code configured to cause an apparatus to:
receive historical link usage information and predicted future link usage information associated with the signal conductor;
determine an imminent change in link usage based on the historical link usage information and the predicted future link usage information received; and
trigger the signal conductor to transition from a current operational state to a subsequent operational state in response to determining the imminent change.

20. The computer program product of claim 19, wherein the code is configured to further cause the apparatus to:
dynamically adjust a time period associated with transitioning the signal conductor from the current operational state to the subsequent operational state based on the imminent change in link usage, wherein the current operational state and the subsequent operational state are defined in a sequence of operational power states; and
trigger the signal conductor to transition from the current operational state to the subsequent operational state upon a lapse of the adjusted time period.

21. A control unit, comprising:
a processor;
a non-transitory storage device containing instructions that, when executed by the processor, cause the processor to:
receive historical link usage information and predicted future link usage information associated with a signal conductor;
determine an imminent change in link usage based on the historical link usage information and the predicted future link usage information received; and
trigger the signal conductor to transition from a current operational state to a subsequent operational state in response to determining the imminent change.
